(19) United States
(12) Patent Application Publication
(10) Pub. No.: US 2005/0212969 A1
(43) Pub. Date: Sep. 29, 2005

(54) Apparatus and method of image display with real-time compression

(75) Inventor: Tsung-Heng Chen, Taipei (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: VIA Technologies Inc.

(21) Appl. No.: 11/087,421

(22) Filed: Mar. 23, 2005

(30) Foreign Application Priority Data
Mar. 23, 2004 (TW) 93107761

(51) Int. Cl. H04N 5/70

(52) U.S. Cl. 348/569

(57) ABSTRACT

A method and apparatus of displaying image with real-time compression and decompression. An on screen display (OSD) data and an image data are overlaid and output for display and the efficiency of display is increased through real-time compression and decompression of the on screen display data, thereby reducing bandwidth for accessing memory.

### BACKGROUND

The present invention relates to an apparatus and method of image display, and more particularly to a method and apparatus of displaying images with real-time OSD (on screen display) data compression and decompression.

Typically an electronic drive including a display presents both images and on screen display (OSD) data. OSD data includes text, cursors and graphs for interactive control of the display apparatus. In digital camera, recorder and player products, a conventional method for displaying the OSD data includes overlaying the image data and the OSD data in a memory, and outputting the final result to a LCD or TV.

As shown in FIG. 1, different segments of memory 101 store image data 102 and OSD data 103. These data are then input to a graphic engine 105, after overlaying by an overlaying unit 104, result is output to a LCD 106 or TV 107.

OSD data 103 is not as complicated as image data 102, and primarily includes predetermined text of a single color. Thus commonly used characters, numbers and symbols are stored in a program data segment or in read-only memories (ROMs) bundled with the product. When needed, these data are read and rearranged to output desired OSD data 103. Usually OSD data 103 are highly repeated so many times since they are certain predetermined characters and symbols, such that when accessing these OSD data 103, the bandwidth of memory 101 is reduced, also the power consumption of memory 101 is increased.

### SUMMARY

An object of the present invention is to provide an image display method capable of real-time OSD compression. The image display method includes the following steps. First, an image data and an on screen display (OSD) data are stored in a memory. Thereafter, the OSD data is compressed, and the compressed OSD data is also stored in the memory and transferred to a graphic engine. The compressed OSD data is then decompressed by the graphic engine, and obtaining a decompressed OSD data. The graphic engine overlays the decompressed OSD data and the image data, an output image is generated.

Another object of the present invention is to provide a display apparatus with real-time OSD compression. The display apparatus includes an encoder, a decoder and an overlaying unit. The encoder compresses an on screen display (OSD) data into a compressed OSD data. The decoder decompresses the compressed OSD data into a decompressed OSD data which equals to the original OSD data, and the overlaying unit generates an output image by overlaying the decompressed OSD data and an image data.

The display apparatus further includes a memory for storing the image data, the OSD data and the compressed OSD data, and a display for displaying the output image. The display is a liquid crystal display (LCD) or Television (TV).

### BRIEF DESCRIPTION OF THE DRAWINGS

The following detailed description, given by way of example and not intended to limit the invention solely to the embodiments described herein, will best be understood in conjunction with the accompanying drawings, wherein:

FIG. 1 shows a display product according to the related art;

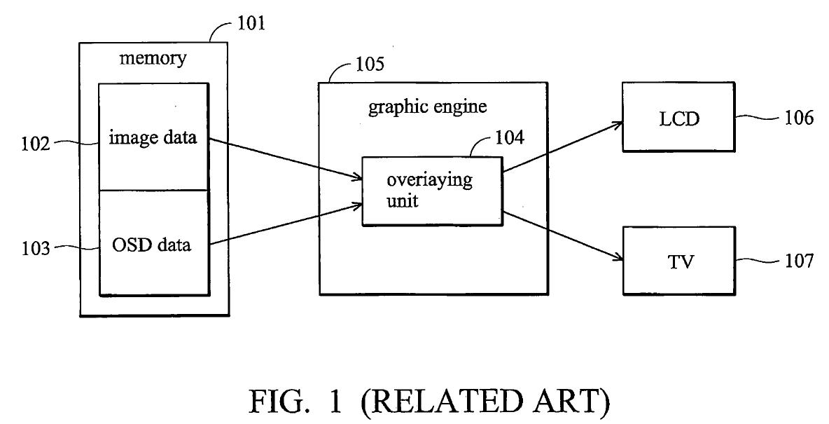

FIG. 2a shows a display product of an embodiment of the present invention;

FIG. 2b is a flowchart according the FIG. 2;

FIG. 3a is a flowchart showing a run length encoding process; and

FIG. 3b is a flowchart showing a run length decoding process.

### DETAILED DESCRIPTION OF THE INVENTION

A detailed description of an embodiment of the present invention is provided in the following.

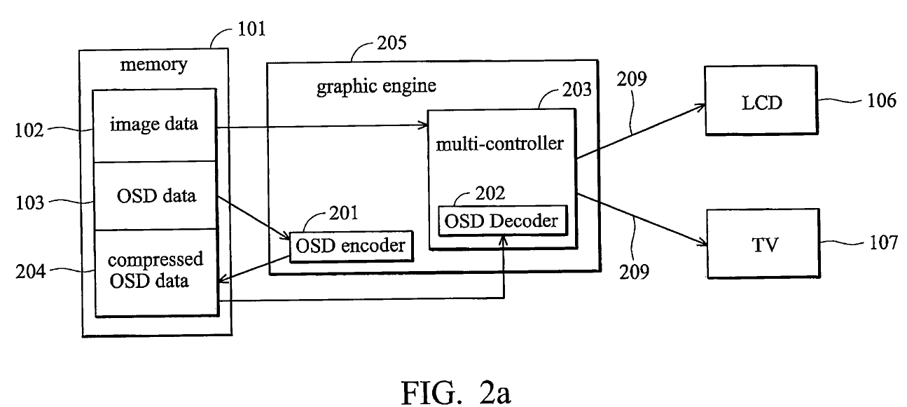

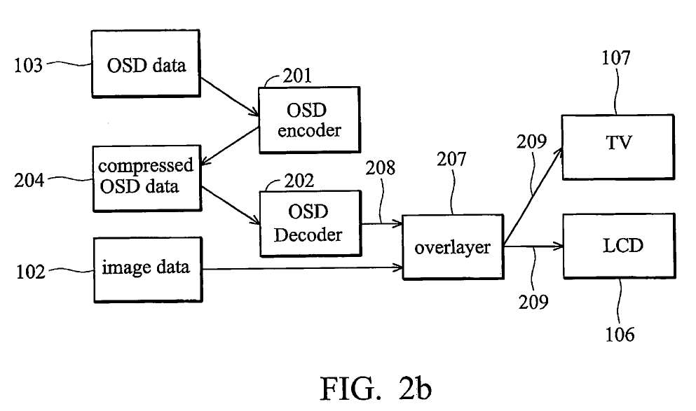

Please reference to FIG. 2a, which shows a display product of an embodiment of the present invention, including a memory 101 for storing an image data 102, an OSD data 103 and a compressed OSD data 204; a graph engine 205 for encoding and decoding the OSD data 103 and the compressed OSD data 204 then perform overlaying process to generate an output image 209; and a LCD 106 or a TV 107 for displaying the output image 209. The graph engine 205 includes an OSD encoder 201 and a multi-controller 203. The OSD encoder 201 encodes the OSD data 103 to the compressed OSD data 204, and an OSD decoder 202 in the multi-controller 203 decodes the compressed OSD data 204 and obtains decompressed OSD data, then the multi-controller 203 overlays the decompressed OSD data 204 and the image data 102. Once the OSD data 103 is compressed to the compressed OSD data 204, the graphic engine 205 stops accessing the segment of OSD data 103 in memory 101, the graphic engine 205 accesses the segment of the compressed OSD data 204 in memory 101 instead. As shown in FIG. 2a, the major heuristic is, since the OSD data 103 is based on certain predetermined characters and symbols, if transferred in a compressed form, the transfer efficiency can be enhanced, and the power consumption of memory can also be reduced.

Another display product of an embodiment of the present invention is provided, please reference to FIG. 2b, including an OSD encoder 201 for compressing an OSD data 103 to a compressed OSD data 204; an OSD decoder 202 for decoding the compressed OSD data 204 then obtaining a decompressed OSD data 208; and an overlayer 207 for overlaying the decompressed OSD data 208 and a image data 102 and generating an output image 209.

In an embodiment of the invention, as shown in FIG. 2b, the image display method includes the following steps. First, image data 102 and OSD data 103 are provided. The image data 102 can be a picture captured by a digital camera, or from another input. The OSD data 103 is then compressed into compressed OSD data 204 and stored in a data segment of memory 101 in the device. The memory 101 may be video memory storing synchronous data, and the compression may processed by an OSD encoder 201. The compressed OSD data 204 and image data 102 are then read into the graphic engine 205, decompressed in real-time and overlaid with image data 102 to obtain an output image 209 for output. The compression is accomplished through an algorithm called Line-Based Run-Length encoding, whereby the same data information can be considerably reduced because data quantity is dozens of times smaller than in conventional methods.

As shown in FIG. 2a, the method of compressing the OSD data 103 includes the following steps. First, reading an OSD data 103 from a memory 101; and compressing the OSD data 103 and obtaining a compressed OSD data 204 which is saved in the memory 101; wherein a device such as an OSD encoder 201 can achieve to compress process. In an embodiment of the invention, the source of OSD data 103 is a user interface programs embedded in the digital camera. The program generates text and graphics as an interface for control of the device. The mentioned text and graphics are typically highly repetitive, thus a caching mechanism is provided to increase convenience and efficiency. The repetitive data are decompressed and output in real-time without additional occupation of data transfer bus and the OSD encoder 201.

In FIG. 2b, the compressed OSD data 204 is read from memory 101, and is then decompressed into decompressed OSD data 208 by OSD decoder 202. An output image 209 is produced after overlaying the decompressed OSD data 208 and the image data 102, and is displayed on LCD 106 or TV 107. In practice decompressed OSD data 208 and OSD data 103 are physically identical, but are given different names to indicate different positions in the process. The method of overlaying includes taking the image data 102 as background, the OSD data 103 as foreground, and directly producing an output image 209 by overlaying. Alternatively, the transparency of the two images can be adjusted before overlaying, wherein the overlaying mode can be color mixing, AND/OR/XOR operation, or one of other known algorithms. The overlaying process is accomplished in an overlayer 207 shown in FIG. 2b, which can be part of the graphic engine, or an external chip module.

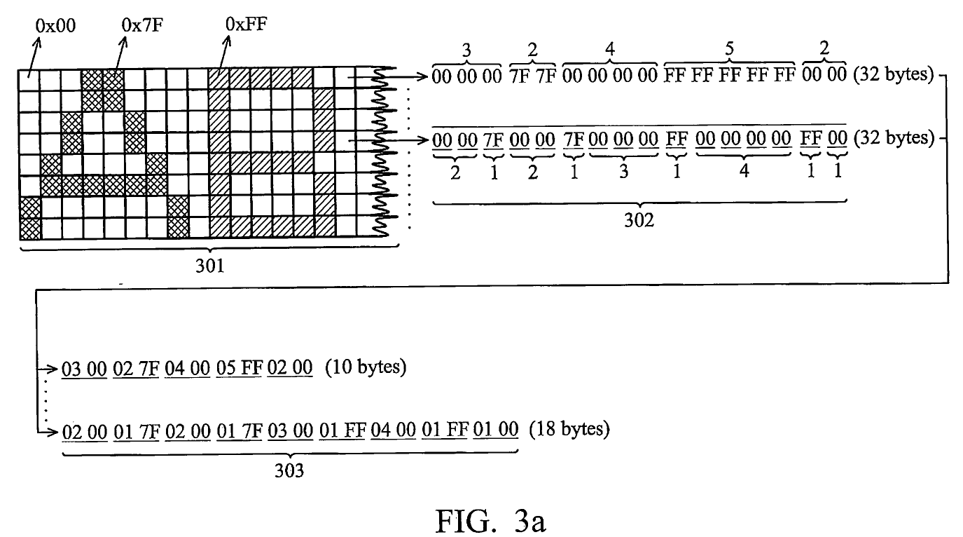

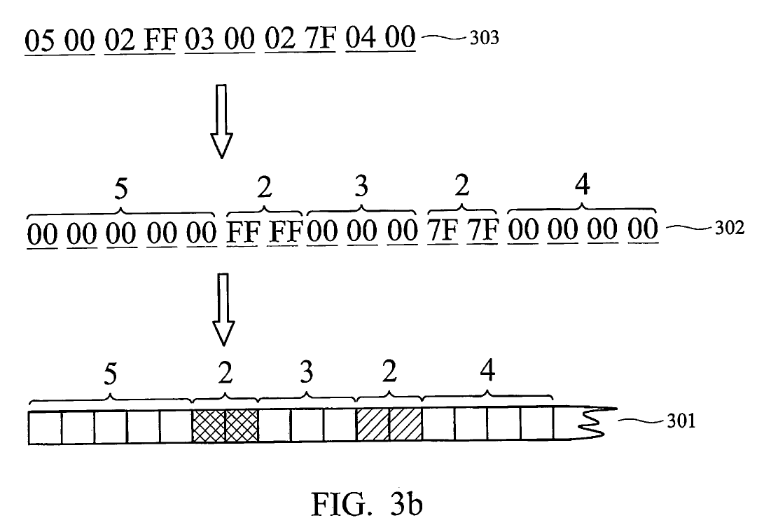

FIG. 3a shows a compression process of run-length encoding algorithm. Pictures are digitally included of color bitmaps; therefore no matter what format the image data 102 is stored in memory 101, a conversion process is required for output of the output image 209. For example, two characters “AB” are shown in bitmap 301 of FIG. 3a. Each unit grid of the bitmap 301 is one byte representing the brightness of one pixel, ranging from 0 to 255. In optics theory, the composition of the three primary colors, red, blue, and green, can produce any color. Three bitmaps, each recording one primary color, can therefore completely record one color image. In an embodiment of the invention, the bitmap 301 is a gray scale bitmap, in which value 0 represents black and value 255 represents white, and values there-between represents various levels of brightness.

In FIG. 3a, the character “AB” in bitmap 301 corresponds to a series of numbers in the memory, shown as sequence 302. For example, in line one, hexadecimal value 0×00 corresponds to a white pixel, 0×ff is a black pixel, and 0×7f maps to a gray pixel. The line-based run-length encoding begins in the OSD encoder 201. First, the sequence 302 is read line by line. In line one, the first three 00 bits are encoded as 03 00 and stored in a stack, representing “three consecutive 00”. Thereafter, according to the same rule, the following two 7F are encoded as 02 7F and stored in the stack, representing “two consecutive 7F”. In this way, a 32 bit sequence can be encoded to a sequence of only 10 bytes. Line four, for example, is compressed to 18 bytes, as shown in compressed sequence 303. In one case, if a consecutive string of 255 bits are all 00, it is encoded as “FF 00” which only occupies two bytes, thus a great efficiency is enhanced.

FIG. 3b shows an embodiment of a decompression process using line-based run-length encoding algorithm, wherein the OSD decoder 202 in FIG. 2a decompresses compressed OSD data 204 into decompressed OSD data 208 in real-time without occupying additional memory and computation resources. In FIG. 3b, a compressed sequence 303 is part of the compressed OSD data 204 stored in the memory 101, and is read into the OSD decoder 202 when decompression begins. The OSD decoder 202 reads two bytes at a time, wherein the first byte is taken as a consecutive number, and the second byte is the brightness of pixel. For example, two bytes “05 00” are first read, representing “five consecutive 00”, thus the extracted result is “00 00 00 00 00”. In the same way, the next read bytes are “02 FF”, representing “two consecutive FF”, and “FF FF” is then extracted, as shown in sequence 302 of FIG. 3b. Through repetition of the decompression, the bitmap 301 is therefore obtained efficiently in real-time, and the overlaying step then outputs a final result on the screen.

According to the embodiments described above, the invention provides an efficient real-time compression and decompression hardware method and apparatus for digital display products, reducing bandwidth of accessing memory and the power consumption during data transfer.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art) Therefore, the scope of the appended claims should be accorded the broadest interpretation so as to encompass all such modifications and similar arrangements.

1. An image display method with real-time compression for use in an electronic device, comprising the following steps:
providing an image data;
producing an on screen display (OSD) data for display;
compressing the OSD data into compressed OSD data;
decompressing the compressed OSD data into a decompressed OSD data; and
generating an output image by overlaying the decompressed OSD data and the image data;
wherein the decompressed OSD data equals to the OSD data and the OSD data comprises a plurality of lines.

2. The image display method as claimed in claim 1, wherein the compression step comprises:
encoding consecutive identical byte data in the lines into data pairs (number of bytes, byte value); and
storing the data pairs corresponding to each line in a sequence.

3. The image display method as claimed in claim 1, wherein the decompression step comprises the following steps:
reading a sequence of data pairs corresponding to each line, wherein each data pair comprises two elements, a number of bytes, and a byte value;
extracting each data pair into a stack according to the number of bytes and the byte value therein; and
recombining the extracted data in the stack line by line to obtain the decompressed OSD data.

4. A display apparatus with real-time compression, comprising:
an encoder, for compressing an on screen display (OSD) data into a compressed OSD data; and
a multi-controller, for generating an output image by overlaying a decompressed OSD data and an image data, comprising:
a decoder, for decompressing the compressed OSD data into the decompressed OSD data;
wherein the decompressed OSD data equals to the OSD data and the OSD data comprises a plurality of lines.

5. The display apparatus as claimed in claim 4, further comprising:
a memory, for storing the image data, the OSD data and the compressed OSD data; and
a display, for presenting the output image.

6. The display apparatus as claimed in claim 4, wherein:
the encoder encodes consecutive identical byte data in the lines into data pairs, wherein each data pair comprises two elements, a number of bytes, and a byte value; and
the encoder writes the data pairs corresponding to each line into the memory in a sequence.

7. The display apparatus as claimed in claim 4, wherein:
the multi-controller reads a sequence of data pairs corresponding to each line from the memory, and each data pair comprises two elements, a number of bytes, and a byte value;
the multi-controller extracts each data pair into a stack according to the number of bytes and the byte value therein; and
the multi-controller recombines the extracted data in the stack line by line to obtain the decompressed OSD data.

8. An image display method with real-time compression on an electronic device, comprising the following steps:
providing an image data and an on screen display (OSD) data from a memory;
compressing the OSD data into a compressed OSD data through a graphic engine;
writing the compressed OSD data into the memory;
transferring the compressed OSD data from the memory to the graphic engine;
decompressing the compressed OSD data into the decompressed OSD data through the graphic engine; and
outputting an output image by overlaying the image data and the decompressed OSD data through the graphic engine;
wherein the decompressed OSD data equals to the OSD data and the OSD data comprises a plurality of lines.

9. The method as claimed in claim 8, wherein the compression step comprises the following steps:
reading the OSD data; and
compressing the OSD data into the compressed OSD data according to a data length and a data type of the OSD data.

10. The method as claimed in claim 8, wherein the compression step comprises the following steps:
encoding consecutive identical byte data in the lines into data pairs, wherein each data pair comprises two elements, a number of bytes, and a byte value; and
writing the data pairs corresponding to each line into the memory in a sequence.

11. The method as claimed in claim 8, wherein the decompression step comprises the following steps:
reading a sequence of data pairs corresponding to each line, wherein each of the data pair comprises two elements, a number of bytes, and a byte value;
extracting each data pair into a stack according to the number of bytes and the byte value therein; and
recombining the extracted data in the stack line by line to obtain the decompressed OSD data.

12. A display apparatus with real-time compression, comprising:
a memory, for storing an on screen display (OSD) data and an image data;
a graphic engine, for accessing the memory and generating an output image, comprising:
an encoder, for compressing the OSD data into a compressed OSD data, and writing the compressed OSD data into the memory;
a multi-controller, for reading the compressed OSD data from the memory decompressing it into the decompressed OSD data, and outputting the output image by overlaying the image data and the decompressed OSD data;
wherein the decompressed OSD data equals to the OSD data and the OSD data comprises a plurality of lines.

13. The display apparatus as claimed in claim 12, further comprising a display for presenting the output image.

14. The display apparatus as claimed in claim 12, wherein the multi-controller further comprises a decoder, for decompressing the compressed OSD data into the decompressed OSD data.

15. The display apparatus as claimed in claim 12, wherein:
the encoder encodes consecutive identical byte data in the lines into data pairs, wherein each data pair comprises two elements, a number of bytes, and a byte value; and
the encoder writes the data pairs corresponding to each line into the memory in a sequence.

16. The display apparatus as claimed in claim 12, wherein:
the multi-controller reads a sequence of data pairs corresponding to each line from the memory, and each data pair comprises two elements, a number of bytes, and a byte value;
the multi-controller extracts each data pair into a stack according to the number of bytes and the byte value therein; and
the multi-controller recombines the extracted data in the stack line by line to obtain the decompressed OSD data.

17. A display apparatus with real-time compression, comprising:
an encoder, for compressing an on screen display (OSD) data into a compressed OSD data;
a decoder, for decompressing the compressed OSD data into a decompressed OSD data; and
an overlayer, for generating an output image by overlaying the decompressed OSD data and an image data;
wherein the decompressed OSD data equals to the OSD data and the OSD data comprises a plurality of lines.

18. The display apparatus as claimed in claim 17, further comprising:
a memory, for storing the image data, the OSD data and the compressed OSD data; and
a display, for presenting the output image.

19. The display apparatus as claimed in claim 17, wherein:
the encoder encodes consecutive identical byte data in the lines into data pairs, wherein each data pair comprises two elements, a number of bytes, and a byte value; and
the encoder writes the data pairs corresponding to each line into the memory in a sequence.

20. The display apparatus as claimed in claim 17, wherein:
the decoder reads a sequence of data pairs corresponding to each line from the memory, and each data pair comprises two elements, a number of bytes, and a byte value;
the decoder extracts each data pair into a stack according to the number of bytes and the byte value therein; and
the decoder recombines the extracted data in the stack line by line to obtain the decompressed OSD data.
